(19) United States
(12) Patent Application Publication
(10) Pub. No.: US 2021/0222099 A1
(43) Pub. Date: Jul. 22, 2021

(54) A METHOD FOR MAKING A COMPOSITE ALCOHOLIC BEVERAGE

(71) Applicant: ARD Core Pty Limited, Sydney, New South Wales (AU)

(72) Inventors: William John Malcom Edwards, Frenchs Forest, Sydney (AU); David Aaron Wilheim Withers, Frenchs Forest, Sydney (AU)

(21) Appl. No.: 17/055,362

(22) PCT Filed: May 17, 2019
(86) PCT No.: PCT/AU2019/000059

§ 371 Date: Nov. 13, 2020

(30) Foreign Application Priority Data
May 18, 2018 (AU) 2018901745
Apr. 17, 2019 (AU) 2019100418

(51) Int. Cl. C12G 3/04; C12G 3/021

(52) U.S. Cl. CPC C12G 3/04; C12G 3/021

(57) ABSTRACT

A method for making a composite alcoholic beverage, the method including the steps of: making a plurality of alcoholic beverages, each of the plurality of alcoholic beverages being made from an individual malt or an individual grain, either separately or together with a base malt or base grain; and, mixing the plurality of alcoholic beverages to make the composite alcoholic beverage.

### TECHNICAL FIELD

The present invention relates to a method for making a composite alcoholic beverage. According to one particular example, the present invention relates to a method for making whisky and the product produced by the method.

### BACKGROUND OF THE INVENTION

The following references to and descriptions of prior proposals or products are not intended to be and are not to be construed as, statements or admissions of common general knowledge in the art. In particular, the following prior art discussion does not relate to what is commonly or well known by the person skilled in the art, but assists in the understanding of the inventive step of the present invention of which the identification of pertinent prior art proposals is but one part.

Currently, in the process of making an alcoholic beverage, such as whisky or the like, desired grains and/or malts (usually one or two varieties and typically not roasted) are ground in a mill and added to a mash vessel all together for brewing. Once brewing is complete, the sweet liquid (called wort) is drained off and pumped into a fermentation vessel where yeast is added. The yeast converts the sugars in the wort into alcohol, carbon dioxide and a number of other secondary compounds. Once fermentation is complete, the liquid (now called wash) is put through a distillation process where the desired alcohol is concentrated and collected (distillation is typically done twice or even three times). The final spirit (often referred to as new make) is then filled into a cask or casks to mature for the desired/required number of years. On maturation, the now aged spirit is then bottled as whisky.

Accordingly, the taste of the whisky created is thus dependent on a number of factors, such as for example, the maturation and casks used, and even the distillation process, as well as, the grains or malts used to begin with.

Commercially, certain types of whisky are well known due to the place where they are made. For example, Scotch whisky is made in Scotland, whereas Bourbon is made in the United States. These whisky beverages can have geographical associations which affect their taste which may also be affected by the method by which they are made. Thus, it is often desirable to make a new type of whisky or spirit, which can have a particular taste that is commercially appealing.

The present invention seeks to provide a method for making a composite alcoholic beverage, which may ameliorate the shortcomings and disadvantages of prior art beverages or which will at least provide a useful alternative.

### SUMMARY OF THE INVENTION

According to one aspect of the invention, there is provided herein a method for making a composite alcoholic beverage. The method can include making the composite alcoholic beverage from a plurality of alcoholic beverages, and mixing the alcoholic beverages to form the composite alcoholic beverage.

According to a further example of the present invention, there is provided herein a method for making a composite alcoholic beverage, the method including the steps of: making a plurality of alcoholic beverages, each of the plurality of alcoholic beverages being made from an individual malt or an individual grain, either separately or together with a base malt or base grain; and, mixing the plurality of alcoholic beverages to make the composite alcoholic beverage.

In one particular example, the method of making the composite alcoholic beverage includes the method of making a spirit, and in a further example, the spirit is a whisky. However, it will be appreciated by persons skilled in the art that the composite alcoholic beverage can be any form of beverage made from a raw ingredient, where the composite alcoholic beverage is formed by combining a plurality of alcoholic beverages made from the raw ingredient.

According to yet another example, the individual malt or individual grain is either roasted or unroasted.

In yet another form, making each of the plurality of alcoholic beverages includes: brewing a first individual malt, either separately or together with a first base malt in a vessel to create a malt wort; fermenting the malt wort to create a malt wash; distilling the malt wash to create a new make; and, maturing the new make in a cask.

According to another example, the method includes making a predetermined number of alcoholic beverages to make the composite alcoholic beverage. However, it will be appreciated that the number of alcoholic beverages need not be predetermined and can be determined at any time through the process. In one particular example, the number of alcoholic beverages and the ratio is determined based on a particular/specific desired taste profile for the composite alcoholic beverage.

According to another form, the method can further include selecting one or more casks of a brew of an alcoholic beverage to mix with another selection of one or more casks of another brew, based on the predetermined number of alcoholic beverages. That is, the method can further include selecting one or more casks from each of the predetermined number of alcoholic beverages to mix to form the composite alcoholic beverage. Thus, for example, it may be determined that the composite alcoholic beverage will include a mix of three alcoholic beverages as a predetermined number. Thus, depending on a desired taste or outcome, the ratio of the selection of the one or more casks need not be the same and can be varied accordingly. For example, one cask from a first alcoholic beverage (or brew) can be chosen, two casks from a second alcoholic beverage, and three from the third, etc., and these rations can be varied accordingly.

According to another particular example, the method includes making six alcoholic beverages. It will be appreciated that the number of alcoholic beverages is not limited to six and can be determined depending on the desired taste profile for the composite alcoholic beverage.

According to a further example, the method includes bottling the composite alcoholic beverage. In yet another aspect, the method includes leaving the composite alcoholic beverage to rest prior to bottling.

There is also provided herein, according to one aspect of the invention, a composite alcoholic beverage made by any of the methods/processes described herein.

It will be appreciated that any combination of the features described herein can be applied in the method for making the composite alcoholic beverage.

### BRIEF DESCRIPTION OF THE DRAWINGS

The invention may be better understood from the following non-limiting description of a preferred embodiment, in which:

FIG. 1 is a flow chart showing an example method for making a composite alcoholic beverage; and,

FIG. 2 is a flow chart showing another example for making a composite alcoholic beverage.

### DETAILED DESCRIPTION OF THE DRAWINGS

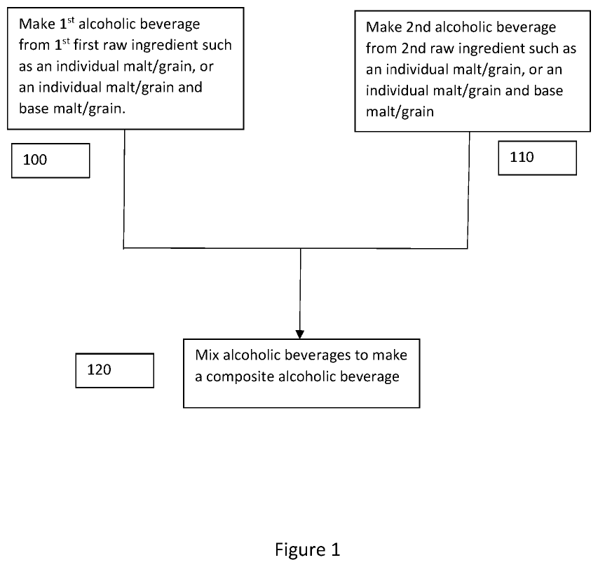

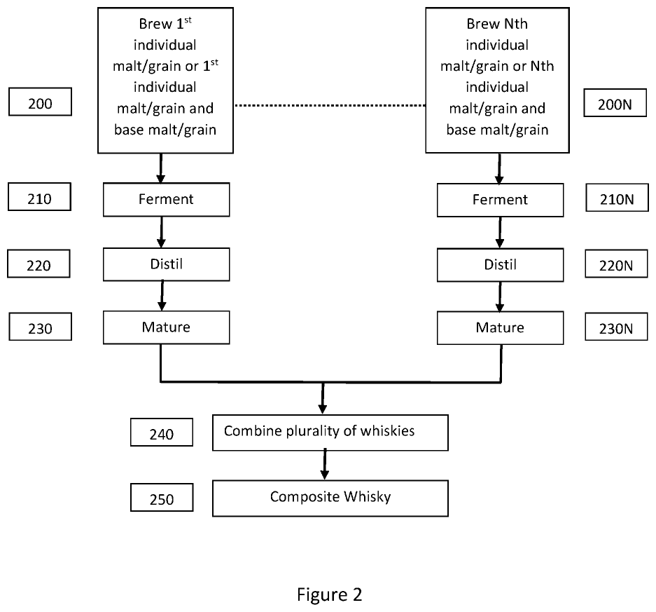

An example of a method for making a composite alcoholic beverage is shown in FIGS. 1 and 2.

In these examples, the method for making a composite alcoholic beverage includes making a plurality of alcoholic beverages, where each of the plurality of alcoholic beverages is made from an individual malt or an individual grain, either separately or together with a base malt or base grain.

Accordingly, each of the plurality of alcoholic beverages can include any one or a combination of an individual malt (which is malted) or grain (which is unmalted), either with or without a base malt (which is malted) or grain (which is unmalted).

Thus, it will be appreciated that each of the plurality of alcoholic beverages can be made from:
An individual malt; or,
An individual malt and a base malt; or,
An individual malt and a base grain (unmalted); or,
An individual grain (unmalted); or,
An individual grain (unmalted) and a base malt; or,
An individual grain (unmalted) and a base grain (unmalted).

The composite alcoholic beverage is then made by mixing the plurality of alcoholic beverages.

Referring to FIG. 1, an example of a method for making a composite alcoholic beverage is shown where the method includes, at step 100, making a first alcoholic beverage from a first raw ingredient and at step 110, making a second alcoholic beverage, from a second raw ingredient. At step 120, the first alcoholic beverage and the second alcoholic beverage are mixed to form/make the composite alcoholic beverage.

According to one particular example, the first raw ingredient and the second raw ingredient can include an individual malt, or an individual grain, either separately, or together with a base grain or base malt.

Further, the first individual malt/grain and the second individual malt/grain can be the same or a different type of malt/grain.

It will be appreciated by persons skilled in the art that the steps 100 and 110 can be done either sequentially or in parallel, depending on the composite alcoholic beverage being made. Furthermore, the number of alcoholic beverages to be made, to be then ultimately mixed and then formed in the composite alcoholic beverage, can be predetermined, again depending on the type or flavour profile that is required for the composite alcoholic beverage. According to one particular example, if making whisky, due to the long maturation timescales, the decision as to whether a second (or third, fourth, fifth, sixth, etc.) alcoholic beverage is typically made at the beginning of the process so as to have the mature beverages available to blend at the same time at the end of the process, at step 120.

An example process for making whisky is shown in FIG. 2.

In FIG. 2, at step 200 an individual malt or grain that is desired is selected and brewed. It will be appreciated that step 200 can include either brewing an individual malt or an individual grain, either separately or together with a base malt/grain.

At step 210, the brew created is then fermented, and at step 220, the fermented brew then undergoes a distillation process. Notably, distillation can also occur a number of times before the method proceeds to step 230. At step 230, the new make or beverage created is then matured by placing the new make into its own cask or casks for a desired period of time, which can be predetermined, depending on the flavour profile or type of composite alcoholic beverage being created.

FIG. 2 also shows that a number of alcoholic beverages can be created, using the process of steps 210-230 (as shown at steps 210N-230N, respectively). As a plurality or a number of alcoholic beverages are created, each going through their own brewing, fermentation, distillation and maturation process, they are then all combined at step 240, to make a composite whisky at the end. According to one particular example, the plurality of alcoholic beverages can be combined in accordance with specific ratios (as shown for example, in Example 2 below).

Notably, the composite alcoholic beverage can then be left to rest and then bottled before consumption.

According to one example, the number and specific ratio of desired alcoholic beverages formed to then create the final composite alcoholic beverage can be predetermined before starting the process at step 200. This is typically dependent upon the type and/or flavour profile desired in the composite whisky. However, it is also possible to decide on the number and ratio of alcoholic beverages to combine to make the composite alcoholic beverage at any time during the process.

Thus according to one particular example, the plurality of alcoholic beverages can be left to mature and tasted at particular points in time to test for maturation or a particular flavour profile. At this stage, it can be decided which alcoholic beverages are to be mixed or added to a mix to then make the composite alcoholic beverage.

Further examples of this process are provided below with respect to making whisky. However, it will be appreciated by persons skilled in the art that the process described herein is not limited to whisky. Thus for example, the process may be used by not performing distillation or maturation as required to make a certain type of composite alcoholic beverage.

### Example 1

The following is an example of the method described herein, where the method includes a segregated production process for multi-roasted malt whisky production.

Accordingly, in this example, the method includes:
1. Adding each roasted malt into a mash vessel either on its own or with neutral, non-roasted base malt/s, effectively brewing each roasted malt individually. Notably, this can include roasted, non-roasted or dried malts, and is thus not limited to the style or different variety or type of malt;
2. Fermenting the individual roasted malt wort on its own;
3. Distilling the individual roasted malt wash on its own;
4. Maturing the individual roasted malt new make in its own cask or casks; and,
5. Blending the individual roasted malt whisky with other different individual roasted and non-roasted malt whiskies to form the final product (whisky).

In this example, the whisky created comprises six malt whiskies, where each of the six malts (either individually or in combination with a neutral, non-roasted base malt) are separately brewed, fermented, distilled, matured and then blended to create the final composite product.

### Example 2

Provided below is an example recipe, showing how each of the steps of Example 1 can be further applied:
1. Each roasted malt is added into the mash vessel either on its own or with neutral, non-roasted base malt/s, effectively brewing each roasted malt individually.
   a. Brew One: 100% Pale Malt
   b. Brew Two: 30% Pale Malt, 70% Chocolate Roasted Malt
   c. Brew Three: 40% Pale Malt, 60% Heavily Peated Roasted Malt
   d. Brew Four: 20% Pale Malt, 80% Amber Roasted Malt
   e. Brew Five: 10% Pale Malt, 90% Caramel Roasted Malt
   f. Brew Six: 50% Pale Malt, 50% Aromatic Roasted Malt
2. Each individual roasted malt wort is then fermented on its own:
   a. Ferment Wort From Brew One on its own
   b. Ferment Wort From Brew Two on its own
   c. Ferment Wort From Brew Three on its own
   d. Ferment Wort From Brew Four on its own
   e. Ferment Wort From Brew Five on its own
   f. Ferment Wort From Brew Six on its own
3. Each individual roasted malt wash is then distilled on its own:
   a. Distil Wash From Brew One on its own (this may occur once, twice, three times or more—typically twice)
   b. Distil Wash From Brew Two on its own (this may occur once, twice three times or more—typically twice)
   c. Distil Wash From Brew Three on its own (this may occur once, twice three times or more—typically twice)
   d. Distil Wash From Brew Four on its own (this may occur once, twice three times or more—typically twice)
   e. Distil Wash From Brew Five on its own (this may occur once, twice three times or more—typically I twice)
   f. Distil Wash From Brew Six on its own (this may occur once, twice three times or more—typically twice)
4. Each individual roasted malt new make is then matured in its own cask. It will be appreciated by persons skilled in the art that according to current Australian legislation for making whisky, maturation is to occur for at least two years, and can be anywhere from 2 years up, depending on the type of whisky, type of cask, size of cask, and other factors that will be known to persons skilled in the art:
   a. Fill new make spirit from Brew One into its own casks
   b. Fill new make spirit from Brew Two into its own casks
   c. Fill new make spirit from Brew Three into its own casks
   d. Fill new make spirit from Brew Four into its own casks
   e. Fill new make spirit from Brew Five into its own casks
   f. Fill new make spirit from Brew Six into its own casks
5. These individually roasted malt whiskies are then blended with some or all of the other different individual roasted and non-roasted malt whiskies to form the final product (whisky). The following is one example:
   a. Select 10 casks of Brew One Whisky and add to blending vat
   b. Select 3 casks of Brew Two Whisky and add to blending vat
   c. Select 34 casks of Brew Three Whisky and add to blending vat
   d. Select 1 casks of Brew Four Whisky and add to blending vat
   e. Select 18 casks of Brew Five Whisky and add to blending vat
   f. Select 11 casks of Brew Six Whisky and add to blending vat

It will be appreciated that in step 5 above, the number of selected casks of each brew is dependent upon the desired flavour profile. Each individual malt whisky has a very different flavour and intensity, therefore 34 casks of Brew Three Whisky may be required, but only 1 Cask of, in this example, the far more intense Brew Four Whisky.

The final composite whisky is then left to rest for a while before being ready to be bottled. It will be appreciated that the time for leaving the composite whisky to rest can vary and is typically from 48 hours to one month. The composite whisky is also typically left to rest in a stainless steel vat, or a large wooden vat.

It will be appreciated that although the above example describes the use of at least six grains, the method described herein is not limited to the number of grains or malt. In a preferred embodiment, a plurality of grains or malt is used.

Accordingly, the present invention can provide a segregated production process for multi-roasted malt whisky.

It will be appreciated that although the present method has been described mostly in relation to whisky, the method is not limited to whisky and can be applied in making many different types of composite alcoholic beverage, apart from whisky and spirits generally, and can further be applied to grapes to make brandy, or sugar cane products to make rum.

It will be appreciated that any form of the word “comprising”, “comprises”, “comprised”, and the like, as used herein, is used in an inclusive manner and is not excluding or limiting in its meaning.

Those skilled in the art will appreciate that the invention described herein is susceptible to variations and modifications other than those specifically described. All such variations and modifications are to be considered within the scope and spirit of the present invention the nature of which is to be determined from the foregoing description.

1. A method for making a composite alcoholic beverage, the method including the steps of:
a. making a plurality of alcoholic beverages, each of the plurality of alcoholic beverages being made from an individual malt or an individual grain, either separately or together with a base malt or base grain including the following steps for each alcoholic beverage:
i. brewing the individual malt or individual grain, either separately or together with the base malt or base grain in a vessel to create a wort;
ii. fermenting the wort to create a wash;
iii. distilling the wash to create a new make; and,
iv. maturing the new make in a cask.
wherein at least two of the plurality of alcoholic beverages are each made from an individual malt that is roasted; and,
b. mixing the plurality of alcoholic beverages to make the composite alcoholic beverage.

2. The method of claim 1, wherein the method of making the composite alcoholic beverage includes the method of making a spirit.

3. The method of claim 2, wherein the spirit is a whisky.

4. The method of claim 1, wherein the method includes determining a predetermined number of alcoholic beverages to make the composite alcoholic beverage.

5. The method of claim 4, wherein the method further includes selecting one or more casks from each of the predetermined number of alcoholic beverages to mix to form the composite alcoholic beverage.

6. The method of claim 4, wherein the predetermined number of alcoholic beverages is six alcoholic beverages.

7. The method of claim 1, wherein the method includes bottling the composite alcoholic beverage.

8. A composite alcoholic beverage made by the method of claim 1.
